(19) United States
(12) Patent Application Publication
(10) Pub. No.: US 2022/0318042 A1
(43) Pub. Date: Oct. 6, 2022

(54) DISTRIBUTED MEMORY BLOCK DEVICE STORAGE

(71) Applicant: RAMScaler, Inc., Dallas, TX (US)

(72) Inventors: Lucy Charlotte Davis, Southlake, TX (US); Surya Kumari L. Pericherla, Frisco (WA)

(21) Appl. No.: 17/220,551

(22) Filed: Apr. 1, 2021

(51) Int. Cl. G06F 9/455; G06F 9/50; G06F 12/02; G06F 15/173

(52) U.S. Cl. CPC G06F 9/45558; G06F 9/5016; G06F 12/0246; G06F 15/17331; G06F 2009/45583; G06F 2009/45595

(57) ABSTRACT

Described herein are techniques that may be used to generate and allocate memory block devices that include volatile memory for long-term data storage. In some embodiments, such techniques may comprise receiving an indication of a set of memory addresses available on one or more server computing devices, allocating at least a portion of the set of memory addresses to a memory block device. Such techniques may further comprise, upon receiving a request to allocate memory to a virtual machine, instantiating the virtual machine and allocating the memory block device to the virtual machine. Upon receiving a request to decommission the virtual machine, the techniques may further comprise reclaiming the memory block device.

### BACKGROUND

Virtualization, in computing, generally refers to the emulation of a physical construct (e.g., a computer) within a computing environment (e.g., a cloud computing environment). A virtual machine (VM) is typically an emulated computer that is instantiated within the computing environment in order to accomplish a particular goal. In order to instantiate a VM, a number of computing resources are allocated from computing devices that maintain the computing environment to the VM.

Computing devices conventionally utilize different types of memory storage based on volatility needs. In a typical computing environment, non-volatile memory (such as read-only memory (ROM) is typically used for long-term storage of data because the data is unlikely to be lost during a power failure. In contrast, volatile memory (such as RAM) is typically faster to access but is usually only used for short-term data storage as a power failure will result in a loss of that data. However, as computing systems have become more virtualized, data is now stored across a network of computing devices, and power failures have become increasingly rare.

It is worth noting that while computing processing units (CPUs), graphical processing units (GPUs), hard disk drives (HDDs) and solid-state drives (SSDs) such as flash drives are typically allocated within VMs, random access memory (RAM), including dynamic random-access memory (DRAM), is allocated for short term memory, but not for long term storage. Furthermore, there is empirical evidence that Hypervisors and VM's generally under use RAM, resulting in the physical hardware available to the hypervisor generally having a substantial amount of unallocated RAM.

### SUMMARY

Techniques are provided herein for allocating long-term memory to virtual machines (VMs), software containers, or operating systems that comprise blocks of random-access memory (RAM) that may be used for long-term storage. In such techniques, each of the servers in a server pool performs a presentment operation in which it reports an availability of computing resources on that server and particularly an availability of volatile memory. The volatile memory is then allocated to any number of memory block devices that can be presented as a storage device. These memory block devices may then be used to implement a number of virtual machines that each perform a desired function.

In one embodiment, a method is disclosed as being performed by a computing platform, the method comprising receiving an indication of a set of memory addresses available on one or more server computing devices and allocating at least a portion of the set of memory addresses to a memory block device. The method may further comprise, upon receiving a request to allocate memory to a virtual machine, instantiating the virtual machine and allocating the memory block device to the virtual machine as a storage device. The method may further still comprise, upon receiving a request to decommission the virtual machine, reclaiming any space the virtual machine consumed in the memory block device.

An embodiment is directed to a computing device comprising: a processor; and a memory including instructions that, when executed with the processor, cause the computing device to receive an indication of a set of memory addresses available on one or more server computing devices, allocate at least a portion of the set of memory addresses to a memory block device, upon receiving a request to allocate memory to a virtual machine, instantiate the virtual machine, and allocate the memory block device to the virtual machine.

An embodiment is directed to a non-transitory computer-readable media collectively storing computer-executable instructions that upon execution cause one or more computing devices to perform acts comprising receiving an indication of a set of memory addresses available on one or more server computing devices, allocating at least a portion of the set of memory addresses to a memory block device, upon receiving a request to allocate memory to a virtual machine, instantiating the virtual machine, and allocating the memory block device to the virtual machine, set of virtual machines, containers, or operating systems.

Embodiments of the disclosure provide several advantages over conventional techniques. For example, embodiments of the proposed system enable optimization of computing resources by enabling use of volatile memory that frequently goes unused. Additionally, volatile memory (such as RAM) is typically much quicker to access than non-volatile memory. By implementing long-term storage using volatile memory instead of non-volatile memory (as in conventional systems) as described herein, typical processing operations can be sped up dramatically.

The foregoing, together with other features and embodiments, will become more apparent upon referring to the following specification, claims, and accompanying drawings.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates a computing environment in which memory block devices may be implemented as long-term storage for a number of virtual machines, containers, or operating systems;

FIG. 2 is a block diagram showing various components of a computing system architecture that supports allocation of MBDs as memory to a number of VMs;

FIG. 3 depicts an exemplary MBD pool that may be generated as a shared pool of computing resources for allocation to a number of virtual machines in accordance with at least some embodiments;

FIG. 4 depicts a flow diagram illustrating a process for generating and allocating memory block devices as long-term memory in virtual machines in accordance with at least some embodiments;

FIG. 5 depicts a diagram illustrating techniques for allocating presented memory to a number of MBDs in an MBD pool in accordance with at least some embodiments; and

FIG. 6 depicts a flow diagram illustrating a process for generating memory block devices and allocating those memory block devices to virtual machines as long-term memory in accordance with at least some embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Described herein are techniques that may be used to implement blocks of volatile memory as long-term storage in a distributed computing environment. In embodiments, this comprises identifying volatile memory resources available across a number of servers in a server pool and allocating blocks of that volatile memory to memory block devices within a shared memory block device pool. These memory block devices are then allocated to a number of virtual machines based on the needs of the respective virtual machines. Such memory block devices are implemented as long-term storage.

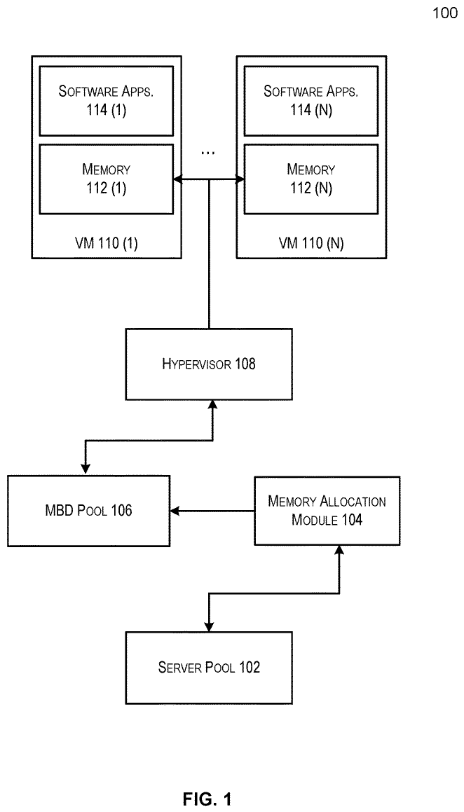

FIG. 1 illustrates a computing environment in which memory block devices (MBDs) may be implemented as long-term storage for a number of virtual machines (VMs), containers, or operating systems. In some embodiments, a computing environment 100 may include a number of computing resources (server pool 102), a memory allocation module 104, a pool of memory block device (MBD) memory (MBD pool 106), at least one hypervisor 108, and a number of virtual machines (VM) 110.

As noted above, the computing environment may include a server pool 102 that includes a plurality of computing resources (e.g., servers). Each of the computing resources within the server pool 102 may include hardware and/or software components that are made available to a number of virtual machines implemented within the computing environment. For example, each computing resource may comprise a computer that includes both long-term and short-term memory that may be accessed by one or more VMs 110. In some embodiments, computing devices of the server pool may be configured to report available computing resources to a memory allocation module 104. In such embodiments, when a physical server operating system is registered within the server pool, it enumerates the server's hardware for reallocation. Embodiments of the system described herein can aggregate hardware from each of the different physical servers and allocate a subset of the hardware aggregated from those physical servers to a cluster of VMs.

The memory allocation module 104 may comprise any software module configured to generate memory block devices from RAM available from computing devices within the server pool. In some embodiments, an MBD may comprise RAM allocated from a number of servers available within the server pool. For example, a single MBD may be generated to include RAM from each of a plurality of different servers, such that data assigned to that MBD for storage is stored across the plurality of different servers. MBDs may be generated by the memory allocation module to be a particular size. Each of the MBDs generated by the memory allocation module may be added to an MDB pool 106. In some embodiments, the size and number of MBDs included within this pool may be predetermined by an administrator.

In some embodiments, an exemplary memory allocation module may be provided with an operating system kernel. For example, one example of a memory allocation module may be the RAM Disk Driver that provides a way to use main system memory as a block device and that is provided with the kernel of the Linux operating system. The Linux implementation of the RAM Disk is a MBD driver like (but not limited to) ZRAM. Note that ordinarily, existing MBD modules (such as ZRAM), are configured to create compressed swap space that is used to support applications or operating systems once all physical memory has been exhausted. In the proposed system, the MBD module creates and makes available MDB storage for hypervisors, virtual machines, containers, applications, and operating systems to consume as normal available storage capacity.

A hypervisor 108 may be any special-purpose software application capable of generating and hosting VMs 110 and allocating available computing resources to those VMs. The hypervisor may generate any number N of VMs (e.g., VMs 110 (1−N)) that is appropriate to complete a particular function. A hypervisor may generate VMs that operate using a number of different operating systems, enabling those VMs to share a common hardware host despite their different operating systems. In various embodiments, creating a VM involves allocating computing resources to the VM and then loading an operating system image (e.g., an ISO or a similar file) onto the allocated computing resources. The operating system image can be a fresh installation media image of the operating system or a snapshot of the running operating system.

Each VM 110 (e.g., 1−N) may comprise an amount of memory 112 and one or more software applications 114 capable of carrying out one or more of the intended functions of the VM. Each of the VMs may be instantiated to include an amount of memory that is appropriate for that VM based on one or more functions intended to be carried out by that VM. For example, a memory 112 (1) of VM 110 (1) may include a larger or smaller amount of memory than a memory 112 (N) of VM 110 (N). Likewise, a composition of the software applications instantiated on each VM may differ based on one or more functions intended to be carried out by that VM. For example, the number and types of software applications 114 (1) instantiated on VM 110 (1) may be different from the number and types of software applications 114 (N) instantiated on VM 110 (N).

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

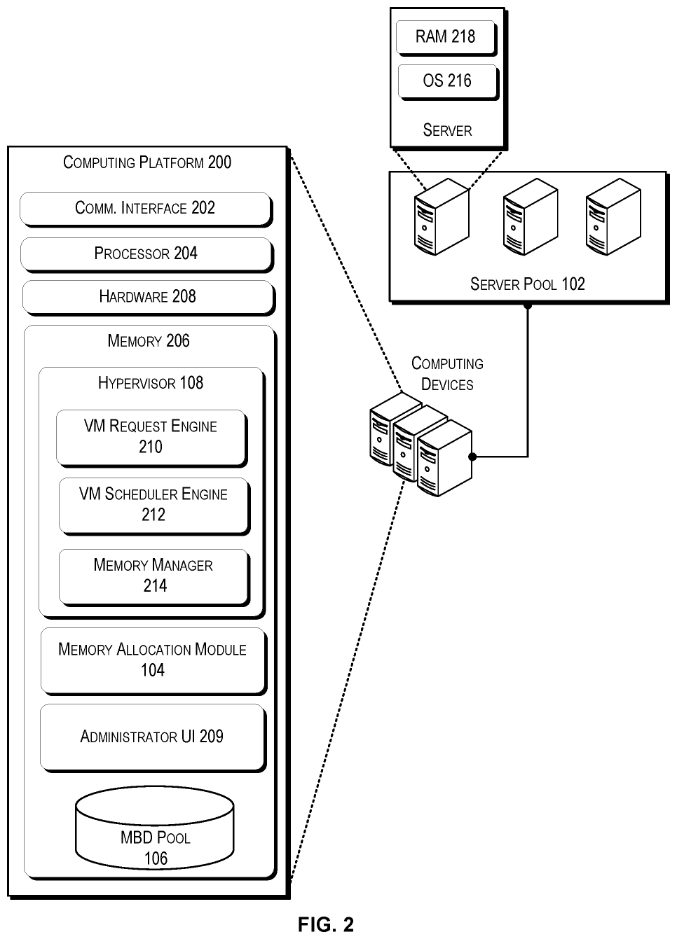

FIG. 2 is a block diagram showing various components of a computing system architecture that supports allocation of MBDs as memory to a number of VMs. The system architecture may include a computing platform 200 that comprises one or more computing devices. The computing platform 200 may include a communication interface 202, one or more processors 204, memory 206, and hardware 208. The communication interface 202 may include wireless and/or wired communication components that enable the computing platform 200 to transmit data to, and receive data from, other networked devices. The hardware 208 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The computing platform 200 can include any computing device configured to perform at least a portion of the operations described herein. The computing platform 200 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, DRAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The one or more processors 204 and the memory 206 of the computing platform 200 may implement functionality from one or more software modules and data stores. Such software modules may include routines, program instructions, objects, and/or data structures that are executed by the processors 204 to perform particular tasks or implement particular data types. The memory 206 may include at least a module for instantiating, and allocating computing resources to, VMs (hypervisor 108), a module for allocating RAM memory to a number of MBDs (memory allocation module 104), and a user interface for enabling interaction between a system administrator and the computing platform 200 (administrator UI 209). The memory 206 may further maintain a pool of MBDs available for allocation to various VMs (MBD Pool 106).

The hypervisor 108 may be configured to, in conjunction with the processor 204, manage VMs as well as allocate computing resources to those VMs. In some embodiments, a hypervisor may include at least a VM request engine 210, a VM scheduler engine 212, and a memory manager 214.

The VM request engine 210 may be configured to, upon receiving (e.g., from a client) a request for a VM to perform a particular function, instantiate (or spin up) a virtual machine configured to perform the specified function. To do this, the VM request engine 210 may identify a format of the VM appropriate for performing the specified function and may allocate computing resources in accordance with that format. In some embodiments, the VM request engine may consult with a database of virtual machine templates to identify a virtual machine template that is appropriate for the received request. In other words, the VM request engine 210 may identify a format of a virtual machine that includes a composition of computing resources (e.g., hardware and/or software applications) that are needed to complete the indicated function. The VM request engine may then instantiate a VM in response to the request by allocating computing resources to the VM in accordance with the identified template. For example, a template may specify an amount of memory required to perform the function as well as an indication of one or more hardware and/or software components needed to perform the requested function. The VM request engine may be further configured to delete or otherwise end a VM upon making a determination that the VM is no longer needed. For example, the VM request engine may end the generated VM upon determining that the specified function has been performed, a time limit has been exceeded, and/or a request is received to stop the VM). Upon ending a VM, the VM request engine may be configured to reclaim the computing resources associated with the VM in order to reallocate those resources to a different VM.

The VM scheduler engine 212 (sometimes referred to as VMMON) may be any suitable software module configured to manage scheduling of events for the hypervisor. For example, the VM scheduler may schedule a cleanup event during which unassigned resources are reclaimed. In another example, the VM scheduler may schedule an event during which a number of VMs are instantiated (i.e., spun up) or ended in order to suit a predicted demand.

The memory manager 214 (sometimes referred to as an MMU) may be configured to manage memory allocated to VMs that are managed by the hypervisor. More particularly, the memory manager may track RAM allocated to the VMs across different physical servers. For example, the memory manager may maintain access to a memory map that indicates a memory address range associated with each MBD. The memory manager may provide the VM request engine with an indication of an unassigned memory address range to be allocated to a new VM as it is instantiated. When the hypervisor creates an MBD, the hypervisor memory manager serves the addresses of RAM blocks, preferably from a single physical server (to make network latency consistent), but potentially from different physical servers. Those different RAM blocks are then made to have a contiguous addressable space as presented by the memory manager.

The memory allocation module 104 may be configured to, in conjunction with the processor 204, generate MBDs by assigning unallocated RAM memory to blocks. In some embodiments, this comprises the creation of a memory map that stores a mapping between various MBDs assigned to the MBD pool and one or more memory address ranges allocated to that MBD.

The administrator user interface (UI) 209 may comprise any suitable user interface capable of enabling a system administrator to access one or more functions of the computing platform 200. In some embodiments, aspects of the administrator UI 209 are presented on a display device via a graphical user interface (GUI). A system administrator is then provided with the ability to interact with the computing platform by manipulating data presented via the GUI. The system administrator may be given the ability, via the administrator UI, to indicate how many MBDs should be generated/included within an MBD pool as well as the size (e.g., amount of memory) included within those MBDs, what MBDs are replicated (e.g., via a RAIDRAM, or RAIM, or RAIMBD or RAIMRAM), or to update any other suitable setting of the computing platform.

As noted elsewhere, the computing platform 200 may be in communication with a number of servers within a server pool 102. Each server within the server pool may comprise a computing device having at least an operating system (OS) 216 and an amount of random-access memory (RAM) 218. Each server in the server pool may be registered with the computing platform. The OS of each respective server may be configured to, upon being registered with the computing platform, indicate the server's hardware availability to the computing platform so that the hardware can be allocated to one or more MBDs within the MBD pool. Note that the term for a physical server notifying the computing platform that it has hardware available for VMs is called “presentment.” It should be noted that RAM 218 from multiple different servers within the server pool can be allocated to a single MBD.

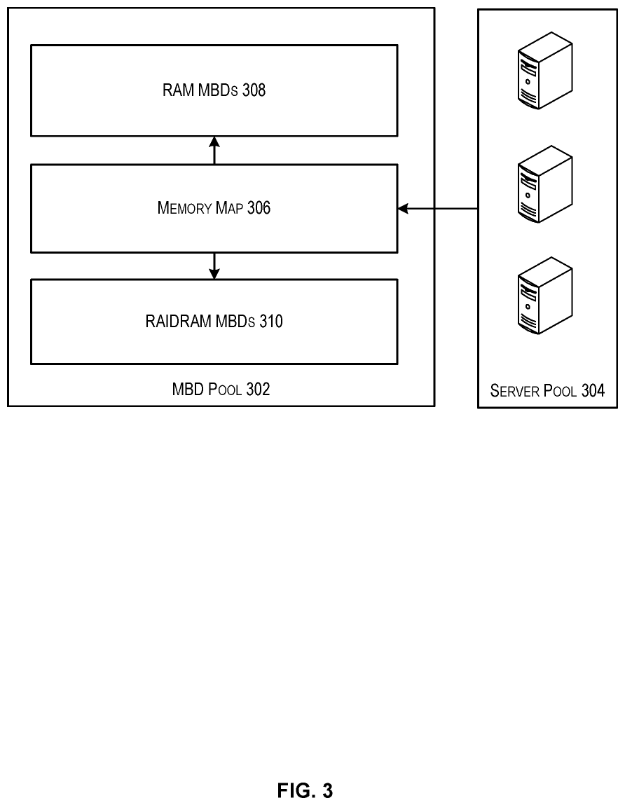

FIG. 3 depicts an exemplary MBD pool that may be generated as a shared pool of computing resources for allocation to a number of virtual machines in accordance with at least some embodiments. As depicted in FIG. 3, an MBD pool 302 may be generated from RAM memory available from servers within in the server pool 304.

Each of the servers in the server pool may report an availability of its respective hardware components (e.g., presentment) to a computing platform (e.g., computing platform 200). Availability of RAM or other memory may be reported as a set of addresses or address ranges for memory available on the server. The available hardware components may then be allocated and/or reserved for the creation of a number of MBDs to be added to the MBD pool. The size (i.e., amount of memory) and number of MBDs created and included within the MBD pool may be predetermined by an administrator.

In some embodiments, a memory map 306 may be maintained that maps each MBD within the MBD pool with a corresponding range of memory addresses within the server pool. It should be noted that a sum of the amount of memory that is reserved for each of the MBDs in the MBD pool may exceed a total amount of memory space indicated as being available by the servers of the server pool. This is because each MBD may have built-in compression that allows for that MBD to store larger amounts of data than the MBD could otherwise store.

When allocating physical memory from a server of the server pool to an MBD, the memory allocation module may attempt to prioritize the allocation of memory blocks from a single physical server to the MBD in order to make network latency consistent. However, if such memory blocks from a single physical server are not available, the memory allocation module may aggregate memory blocks from different servers into a single MBD. However, those memory blocks are then made to have a contiguous addressable space when presented as the MBD.

As depicted, a first portion of the MBD pool may be configured as RAM MBDs 308, and a second portion of the MBD pool may be configured as a Redundant Array of Drives (RAID) RAM MBDs. 310. Implementing a RAID is a strategy of copying and saving data on both a primary MBD and one or more secondary MBD(s). As noted elsewhere, RAM is a type of volatile memory, and data stored within an MBD that relies upon RAM may be lost upon a power failure or a failure of a server to which that MBD's memory space is mapped, which can be problematic for data intended to be stored long-term. In order to reduce the risk of data loss upon a server crash or other single point of failure, each MBD may be replicated to a secondary MDB that comprises memory mapped to a different server than the respective MBD. Data on the MBD can be replicated to SAN or NAS devices and any non-volatile block storage device, including NVMe. In some embodiments, at least some of the RAM MBDs 308 may correspond to at least one RAIMBD 310, such that data stored within that RAM MBD is replicated within the corresponding RAIMBD. In these embodiments, each time that data is updated in one of the RAM MBDs 308 (e.g., by a VM), the same update is made to the corresponding RAIDRAM MBD. In this manner, MBDs composed of volatile memory can be made more suitable for long-term data storage through replication.

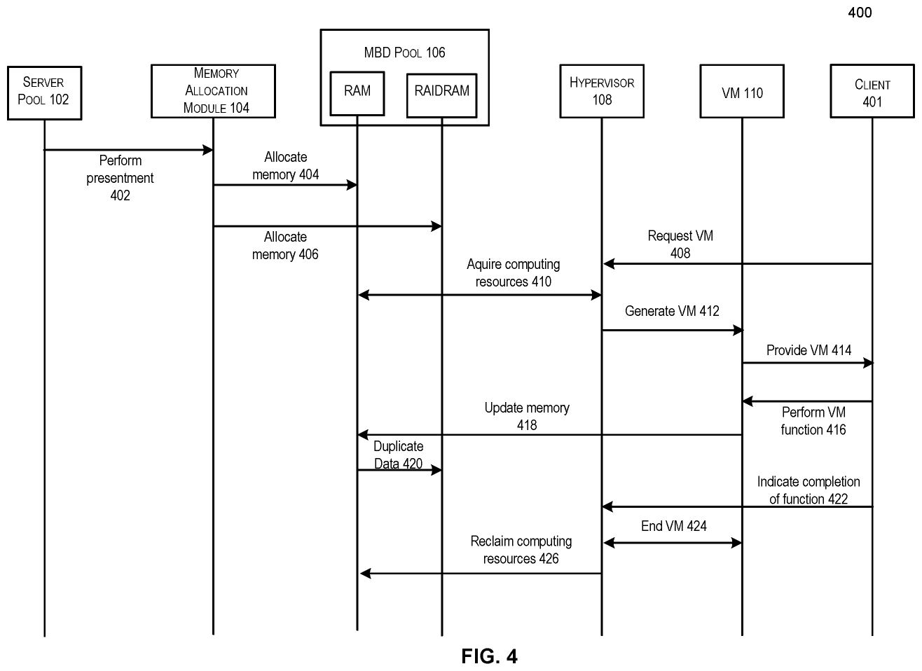

FIG. 4 depicts a flow diagram illustrating a process for generating and allocating memory block devices as long-term storage for a hypervisor to allocate to virtual machines in accordance with at least some embodiments. The process 400 may be performed by one or more components of the computing environment 100 as described with respect to FIG. 1 above. For example, the process 400 may include interactions between one or more servers within a server pool 102, a memory allocation module 104, an MBD pool 106, a hypervisor 108, and one or more virtual machines 110. In addition, the process 400 may include one or more interactions between the components of the computing environment 100 and a client device 401.

At 402 of the process 400, one or more of the servers within the server pool 102 may perform a presentment operation during which that server reports an availability of its computing resources (e.g., memory, processing power, etc.). In some cases, such presentment operations may be performed by a server upon that server being registered with the server pool 102. In some cases, such presentment operations may be performed by one or more servers on a periodic basis (e.g., hourly, daily, weekly, monthly, etc.). During a presentment operation, each server may provide an indication of a set (e.g., a range) of memory addresses that are free (e.g., available for use).

At 404 of the process 400, the memory allocation module may generate a number of MBDs and allocate a set of memory addresses indicated as being free to each of those MBDs. In many cases the generation of MBDs is executed by an administrator. In some embodiments, the memory allocation module 104 may generate a number of RAM MBDs at 404 and a number of RAIDRAM MBDs at 406 that mirror the RAM MBDs. In at least some of these embodiments, each RAIDRAM may correspond to one of the RAM MBDs generated at 404, such that each generated RAIDRAM MBD acts as a backup (i.e., redundant) memory for the respective corresponding RAM MBD within the MBD pool. In some embodiments, each RAIDRAM MBD may be mapped to a corresponding RAM MBD such that any updates made to the memory addresses allocated to the RAM MBD are replicated within the memory addresses allocated to the RAIDRAM MBD.

At 408 of the process 400, A client 401 may request access to a virtual machine from the hypervisor 108. The request may include an indication of a purpose or one or more functions to be performed by the virtual machine. In some embodiments, the request may indicate a type of virtual machine requested and/or a composition of computing resources that should be included within the virtual machine. For example, the request may indicate an amount of memory that should be allocated to the virtual machine and/or a combination of software applications to be included within the virtual machine.

The hypervisor, in response to the request from the client, may identify a VM template that is appropriate based on the request received from the client. In some embodiments, a VM template may be selected based on its relevance to a type of virtual machine requested by the client or a function to be performed by the VM. The template may indicate a combination of computing resources (e.g., memory and/or software applications) to be included within the VM.

At 410 of the process 400, the hypervisor may acquire the computing resources indicated in the client request and/or VM template. This may reserve, from the MBD pool, a sufficient number of RAM MBDs from the MBD pool 106 to cover an amount of memory determined to be needed for the VM. Because each of the MBDs may be of a specific size, the hypervisor may not be able to reserve a number of MBDs that exactly matches the amount of memory needed to instantiate the VM. In these cases, the hypervisor may reserve a number of MBDs that is just greater than the amount of memory required by the VM. For example, if the VM requires 800 megabytes (MB) of memory, and each MBD comprises 512 MBs of memory, then the hypervisor may reserve two MBDs for the VM for a total of 1024 MB of memory.

Once the computing resources have been acquired, the hypervisor may generate the VM at 412. To do this, the hypervisor may allocate one or more of the reserved MBDs as virtual disk storage or storage capacity to the VM and instantiate (within that memory) one or more software applications to be included within the VM. The hypervisor may then serve the VM to the client at 414. In some cases, the hypervisor may serve the VM to the client by providing the client with a link to a location at which the VM can be accessed (e.g., a uniform resource locator (URL) or other suitable link). It should be noted that the MBD served to the client within the VM will appear to that client as an ordinary storage device despite that it is comprised of volatile memory (e.g., RAM). [this is an excellent statement]

Upon being served the VM by the hypervisor, the client may access the VM and use it to perform one or more functions at 416. During the performance of one or more functions by the VM, one or more operations may cause one or more RAM MBDs acting as storage for the VM to be updated at 418 (e.g., to store data).

In some embodiments, upon detecting an update to one or more memory addresses associated with a RAM MBD, that same update may be made to a RAIDRAM MBD mirroring that RAM MBD at 420. If the RAM MBD becomes corrupted or at least one of the underlying servers that host the memory addresses referred to by the RAM MBD lose power, then a new RAM MBD may be generated and allocated to the VM in its place. In this event, data copied to the RAIMBD is copied to the newly generated MBD.

The hypervisor may determine that the VM is no longer needed. In some embodiments, the client may indicate that it is finished using the VM at 422. In some embodiments, the hypervisor may determine that a predetermined amount of time has passed or some function for which the VM was created has been completed. Upon determining that the VM is no longer needed, the hypervisor may delete the VM at 424. This can also be initiated by a VM administrator. Once the VM has been deleted, the MBDs may be reclaimed by the MBD pool at 426 to be reallocated to a different VM.

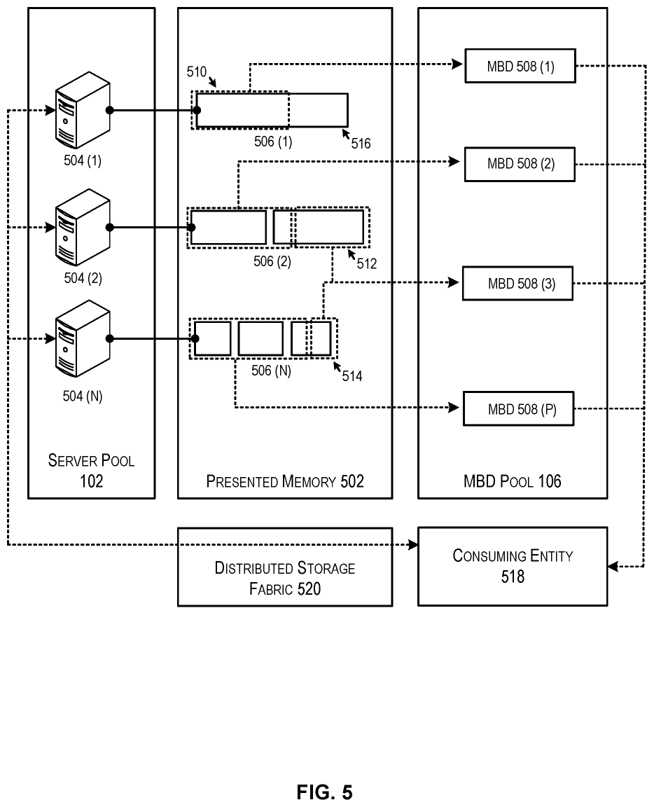

FIG. 5 depicts a diagram illustrating techniques for allocating presented memory to a number of MBDs in an MBD pool in accordance with at least some embodiments. In the diagram of FIG. 5, presented memory 502 represents sets of memory addresses reported as being available by servers within a server pool 102. Each server 504 (1−N) would report a set of memory addresses 506 (1−N) that are available on the respective server. Accordingly, there is a set of memory addresses 506 corresponding to each server 504. The size of each set of memory addresses 506 may vary based on an availability of computing resources for the respective server 504. In some cases, the set of memory addresses may be non-contiguous, in that the set of memory addresses may represent ranges of memory addresses that are separated by blocks of memory that are in use.

A number of MBDs 508 may be generated from the presented memory 502. It should be noted that the number of MBDs 508 that are generated may be set by an administrator and may vary from the number of underlying servers 504. For example, MBDs 508 (1−P) may be generated based on presented memory from servers 504 (1−N) where P is a different integer than N. In some embodiments, each of the generated MBDs may include a predetermined amount of memory. In some embodiments, a particular MBD may include a compression algorithm, allowing the range of memory addresses assigned to that particular MBD may be associated with less physical memory than the predetermined amount.

In order to generate a number of MBDs to be included within a shared MBD pool 106, a memory space 510 of sufficient size to include a predetermined amount of memory may be required. A set of memory addresses may be identified within the presented memory that meets the predetermined amount requirement. In some embodiments, selection of a set of memory addresses from a single server may be prioritized during generation of an MBD. However, in the event that there is an insufficient set of memory addresses available from a single server, sets of memory addresses may be available on different servers. For example, an MBD may be generated by allocating a first set of memory addresses 512 associated with a first server 504 (2) and a second set of memory addresses 514 associated with a second server 504 (N). In some embodiments, if the number of generated MBDs has reached a maximum number (e.g., as set by a system administrator), or if the sets of memory addresses that remain unallocated (e.g., 516) are insufficient to form an MBD, no more MBDs will be generated.

When generating an MBD, a new contiguous range of memory addresses may be assigned to that MBD. A mapping may then be maintained (e.g., memory map 306 of FIG. 3) between the assigned range of memory addresses and the sets of memory addresses allocated to that MBD, such that updates to the assigned range of memory addresses are made to the presented memory allocated to the MBD. It should be noted that any suitable allocation algorithm may be used to allocate the presented memory to an MBD. For example, the process may use a greedy allocation algorithm, an optimistic allocation algorithm, a pessimistic allocation algorithm, or any other suitable algorithm for allocating sets of memory addresses to an MBD.

Once a number of MBDs have been generated within the MBD pool, those MBDs may be allocated to one or more consuming entities 518 as described elsewhere. Such consuming entities 518 may include hypervisors, virtual machines, applications, operating systems and containers as described elsewhere.

In order to use an allocated MBD, the consuming entity 518 may access an underlying memory space (e.g., 510) assigned to the respective MBD on one of the servers 504. In some embodiments, the system may include a distributed storage fabric 520 (also referred to as a Storage Area Network) that is used to provide access to the storage capacity provided by single or multiple MDB(s). Traditional storage transport protocols can be used to enable hypervisors, applications, operating systems and containers to access to this MBD based storage using transmission control protocol (TCP) based networking applicable to a network file system (NFS).

In some embodiments, remote direct memory addressing (RDMA) is used to enable an MBD Pool 106 to span server pools 102, over a storage fabric 520, enabling a memory space 510 to be accessed directly over a storage fabric 520. RDMA-based distributed storage networks can enable memory address ranges (e.g., 512, 514, or 516) to be accessed over networks either directly and individually or grouped together as a cluster of available memory on which MBD devices are created. In such embodiments, consuming entities that use traditional storage network transports (such as NFS and Internet Small Computer Systems Interface (iSCSI)) can be serviced by providing access to MBD based storage capacity over RDMA.

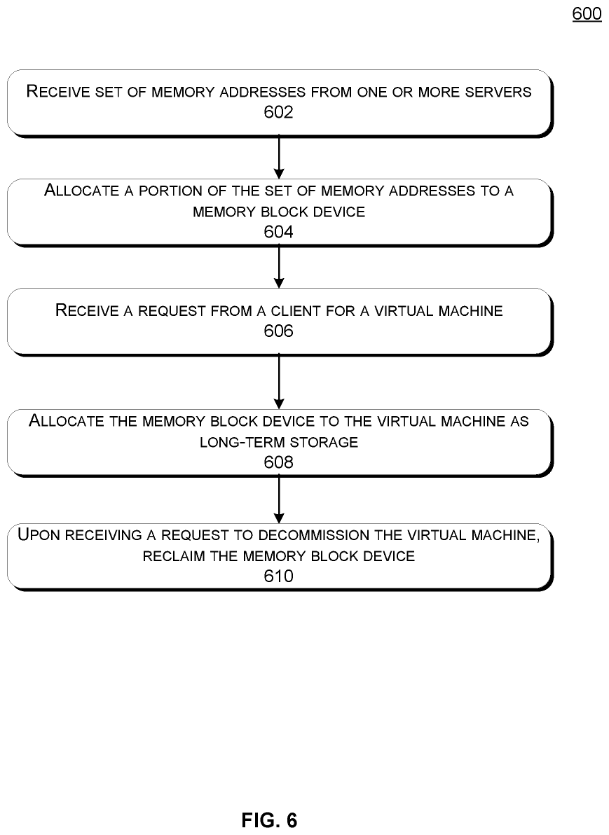

FIG. 6 depicts a flow diagram illustrating a process for generating memory block devices and allocating those memory block devices to virtual machines as long-term memory in accordance with at least some embodiments. The process 600 depicted in FIG. 6 may be performed by the computing platform 200 as described above.

At 602, the process 600 may comprise receiving a set of memory addresses from one or more servers in a server pool. In some embodiments, each of the set of memory addresses are associated with volatile memory. Such volatile memory may comprise RAM memory and/or dynamic random-access memory (DRAM). In some embodiments, the indication of the set of memory addresses available on the one or more server computing devices is received upon each of the one or more server computing devices performing a presentment operation.

At 604, the process 600 may comprise allocating a portion of the set of memory addresses to one or more memory block devices. In some embodiments, the memory block device is added to a shared pool of memory block devices prior to being allocated to the virtual machine. In some embodiments, the memory block device includes a compression algorithm such that a larger amount of data can be stored within the memory block device than would otherwise be capable of being supported by the memory addresses allocated to the MBD. In some embodiments, the portion of the set of memory addresses available on one or more server computing devices comprises a first set of memory addresses associated with a first server computing device and a second set of memory addresses associated with a second computing device. The memory block device may comprise a contiguous block of memory.

In some embodiments, the generated MBD may be added to a shared pool of MBDs to be allocated to various virtual machines. Additionally, in some embodiments at least one redundant memory block device may be generated that corresponds to the memory block device. In such embodiments, updates to the memory block device are replicated to the at least one redundant memory block device. Each of the MBDs in the pool of MBDs may be mapped to a set of memory addresses allocated to it within a memory map.

At 606, the process 600 may comprise receiving a request from a client for a virtual machine. In some embodiments, the request may indicate a purpose or intended function to be performed by the virtual machine. In some embodiments, the request may indicate a time period over which the virtual machine should be implemented and/or conditions under which the virtual machine should continue to be implemented. Based on the received request, the process may further comprise determining one or more computing resources to be implemented within the requested virtual machine.

At 608, the process 600 may comprise instantiating the virtual machine and allocating the memory block device to that virtual machine. In some embodiments, the memory block device is allocated to the virtual machine as long-term storage. In some embodiments, the memory block device comprises one of a plurality of memory block devices allocated to the virtual machine. In such embodiments, the plurality of memory block devices comprise a number of memory block devices determined to be relevant to the operation of the virtual machine. In some cases, the number of memory block devices allocated to the virtual machine is determined based on an intended function of the virtual machine. Such an intended function of the virtual machine is indicated in the request to allocate memory to the virtual machine. In some cases, the number of memory block devices allocated to the virtual machine is determined based on a template identified as being associated with the virtual machine.

In some embodiments, virtual machines may be disposed upon utilization enabling reallocation for new requests. At 610, the process 600 may comprise, upon receiving a request to decommission the virtual machine, reclaiming the memory block device. In some embodiments, this may comprise decommissioning any software applications currently instantiated on the MBD and mark the MBD as unused, allowing the MBD to be reallocated to another virtual machine.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

What is claimed is:

1. A method comprising:
receiving an indication of a set of memory addresses available on one or more server computing devices;
allocating at least a portion of the set of memory addresses to a memory block device;
upon receiving a request to allocate memory to a virtual machine, instantiating the virtual machine; and
allocating the memory block device to the virtual machine.

2. The method of claim 1, wherein the set of memory addresses are associated with volatile memory.

3. The method of claim 2, wherein the volatile memory comprises random access memory.

4. The method of claim 1, wherein the memory block device is allocated to the virtual machine as long-term storage.

5. The method of claim 1, wherein the memory block device is added to a shared pool of memory block devices prior to being allocated to the virtual machine.

6. The method of claim 1, wherein the memory block device includes a compression algorithm.

7. The method of claim 1, wherein the portion of the set of memory addresses available on one or more server computing devices comprises a first set of memory addresses associated with a first server computing device and a second set of memory addresses associated with a second computing device.

8. A computing device comprising:
a processor; and
a memory including instructions that, when executed with the processor, cause the computing device to, at least:
receive an indication of a set of memory addresses available on one or more server computing devices;
allocate at least a portion of the set of memory addresses to a memory block device;
upon receiving a request to allocate memory to a virtual machine, instantiate the virtual machine; and
allocate the memory block device to the virtual machine.

9. The computing device of claim 8, wherein the memory block device comprises a contiguous block of memory.

10. The computing device of claim 8, wherein the memory block device comprises one of a plurality of memory block devices allocated to the virtual machine.

11. The computing device of claim 8, wherein the plurality of memory block devices comprise a number of memory block devices determined to be relevant to the operation of the virtual machine.

12. The computing device of claim 11, wherein the number of memory block devices is determined based on an intended function of the virtual machine.

13. The computing device of claim 12, wherein the intended function of the virtual machine is indicated in the request to allocate memory to the virtual machine.

14. The computing device of claim 11, wherein the number of memory block devices is determined based on a template identified as associated with the virtual machine.

15. The computing device of claim 8, wherein the instructions further cause the computing device to instantiate at least one redundant memory block device that corresponds to the memory block device, such that updates to the memory block device are replicated to the at least one redundant memory block device.

16. The computing device of claim 8, wherein remote direct memory addressing (RDMA) is used to access the portion of the set of memory addresses allocated to a memory block device.

17. The computing device of claim 8, wherein the instructions further cause the computing device to, upon receiving a request to decommission the virtual machine, reclaim the memory block device.

18. A non-transitory computer-readable media collectively storing computer-executable instructions that upon execution cause one or more computing devices to collectively perform acts comprising:
receiving an indication of a set of memory addresses available on one or more server computing devices;
allocating at least a portion of the set of memory addresses to a memory block device;
upon receiving a request to allocate memory to a virtual machine, instantiating the virtual machine; and
allocating the memory block device to the virtual machine.

19. The computer-readable media of claim 18, wherein the indication of the set of memory addresses available on the one or more server computing devices is received upon each of the one or more server computing devices performing a presentment operation.

20. The computer-readable media of claim 19, wherein the set of memory addresses are associated with volatile memory and the memory block device is allocated to the virtual machine as long-term storage.
